(19) United States
(12) Patent Application Publication
(10) Pub. No.: US 2008/0115655 A1
(43) Pub. Date: May 22, 2008

(54) PLAYBACK SYSTEMS AND METHODS WITH INTEGRATED MUSIC, LYRICS AND SONG INFORMATION

(75) Inventors: Tsen-Chung Weng, Taipei (TW); Shiau-Jiuan Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/759,346

(22) Filed: Jun. 7, 2007

(30) Foreign Application Priority Data
Nov. 17, 2006 (TW) 95142540

(51) Int. Cl. G10H 7/00

(52) U.S. Cl. 84/609

(57) ABSTRACT

Playback systems and methods with integrated music, lyrics and song information. The system comprises a database and a processing module. The database stores a plurality of music/lyrics/song information integrated files, each corresponding to a song, and comprising a first music, a first lyrics, and first song information. The processing module queries a specific music/lyrics/song information integrated file from the database according to a specific song index, where the specific song index corresponds to the first song information of the specific music/lyrics/song information integrated file. The processing module reads the first music and the first lyrics from the specific music/lyrics/song information integrated file, and plays back a specific song by playing back the first music and the first lyrics.

### BACKGROUND OF THE INVENTION

1. Field of the Invention

The disclosure relates generally to playback systems and methods, and, more particularly to systems and methods that read music, lyrics and song information from an integrated file for playback.

2. Description of the Related Art

Portable devices, such as personal media player, MP3 player and mobile Karaoke player have become popular. During playback, lyrics can be synchronously displayed on these devices, such that users can sing songs accordingly.

FIG. 1 illustrates a conventional playback system. In the conventional playback system 100, a song comprises several files. As shown in FIG. 1, when a designation of a specific song is received, a music file 111, a lyrics file 112 and related song information (not shown) corresponding to the specific song are retrieved from a database 110. Thereafter, the music file 111 is played back via an audio output unit 130, and the lyrics file 112 and the song information is played back (displayed) via a display unit 120.

A song corresponds to at least two files, such as a music file and a lyrics file. For a song with multilingual versions, the number of corresponding files may exceed two. If the song is updated or replaced, all of the corresponding files must be found to delete, copy, and/or replace. After all files are found and updated or replaced, the song can be correctly played back.

A portable playback device with limited capacity can only store a small number of songs compared to a conventional home-use karaoke player. Therefore, the replacement of old songs may be frequent, and specific files may be easily lost, such that songs cannot be correctly played back. The conventional playback system is complex and inconvenient.

### BRIEF SUMMARY OF THE INVENTION

Playback systems and methods with integrated music, lyrics and song information are provided.

An embodiment of a playback system with integrated music, lyrics and song information comprises a database and a processing module. The database stores a plurality of music/lyrics/song information integrated files, each corresponding to a song, and comprising first music, first lyrics, and first song information. The processing module retrieves a specific music/lyrics/song information integrated file from the database according to a specific song index, where the specific song index corresponds to the first song information of the specific music/lyrics/song information integrated file. The processing module reads the first music and the first lyrics from the specific music/lyrics/song information integrated file, and plays back a specific song corresponding to the specific music/lyrics/song information integrated file by playing back the first music and the first lyrics.

In an embodiment of a playback method with integrated music, lyrics and song information, a database is provided. The database stores a plurality of music/lyrics/song information integrated files, each corresponding to a song, and comprising first music, first lyrics, and first song information. When a specific song index is received, a specific music/lyrics/song information integrated file is retrieved from the database according to the specific song index, where the specific song index corresponds to the first song information of the specific music/lyrics/song information integrated file. The first music and the first lyrics are read from the specific music/lyrics/song information integrated file, and a specific song corresponding to the specific music/lyrics/song information integrated file is played back by playing back the first music and the first lyrics.

Playback systems and methods with integrated music, lyrics and song information may take the form of program code embodied in a tangible media. When the program code is loaded into and executed by a machine, the device becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a conventional playback system;

FIG. 2 is a schematic diagram illustrating an embodiment of a playback system with integrated music, lyrics and song information;

FIG. 3 shows an example of a music/lyrics/song information integrated file for single language;

FIG. 4 shows an example of a music/lyrics/song information integrated file for two languages;

FIG. 5 shows another example of a music/lyrics/song information integrated file for two languages;

FIG. 6 is a flowchart of an embodiment of a playback method with integrated music, lyrics and song information; and

FIG. 7 is a flowchart of an embodiment of a playback method with integrated music, lyrics and song information.

### DETAILED DESCRIPTION OF THE INVENTION

Playback systems and methods with integrated music, lyrics and song information are provided.

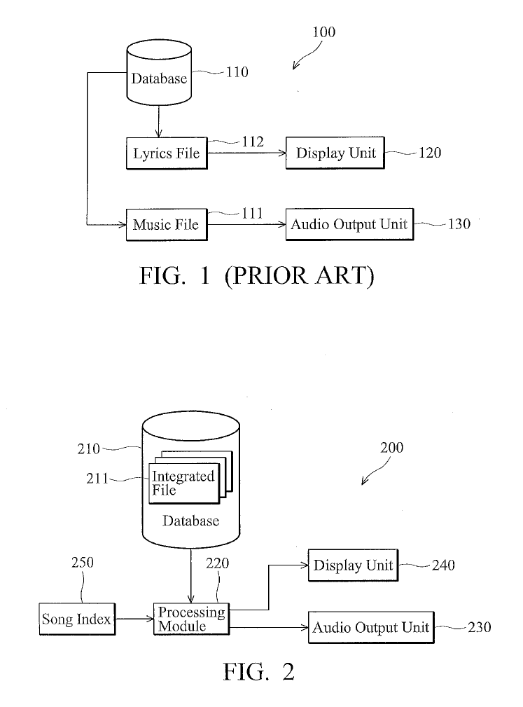

FIG. 2 illustrates an embodiment of a playback system with integrated music, lyrics and song information. The system 200 comprises a database 210, a processing module 220, an audio output unit 230, and a display unit 240.

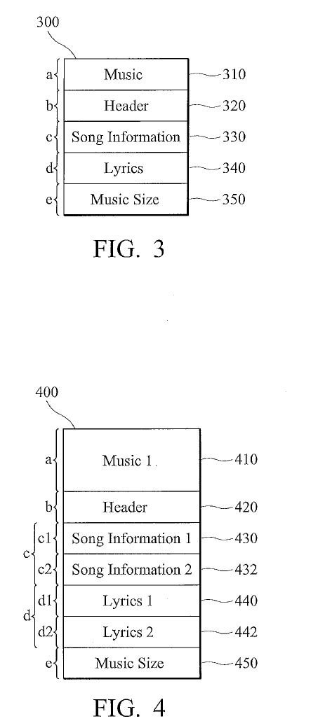

The database 210 stores a plurality of music/lyrics/song information integrated files 211. Each music/lyrics/song information integrated file corresponds to a song, and comprises music, lyrics, and song information. FIG. 3 shows an example of a music/lyrics/song information integrated file for single language. As shown in FIG. 3, the music/lyrics/song information integrated file 300 comprises music 310 such as MP3 music data, music information 330, and lyrics 340 with time information. It is understood that the lyrics 340 comprises at least a specific portion, such as each sentence or section of lyrics, having a time tag. Each time tag corresponds to a time point on a timeline of the music 310. During playback of the music 310, the specific portion in the lyrics 340 can be played back at the corresponding time point. The header 320 records related data of the music 310, song information 330, and lyrics 340, such as the number of the music 310, song information 330, and lyrics 340, and size thereof. The data recorded in the header 320 helps to ensure accuracy during data access. Additionally, the music size 350 records the size of the music 310, used for an index of the beginning of the header 320. In the example of FIG. 3, the size of the music 310 is “a”, the size of the header 320 is “b”, the size of the song information 330 is “c”, the size of the lyrics 340 is “d”, and the size of the field of music size 350 is “e”. The value of the music size 350 is “a”, used for an offset of the music 310. The header 320 comprises a content provider recording vendor ID, a number of music blocks, a number of song information blocks, a number of lyrics blocks, a size of music, a size of song information, and a size of lyrics. In the example of FIG. 3, the number of the music block is 1, the number of the song information block is 1, the number of the lyrics block is 1, the size of the music is “a”, the size of the song information is “c”, and the size of the lyrics is “d”. It is noted that the music 310 may be an encrypted cipher text, and provided by the vendor directly. Additionally, the rest portion of the music/lyrics/song information integrated file 300 can be also encrypted, where the encryption methods for the music 310 and the rest portion of the music/lyrics/song information integrated file 300 may be different.

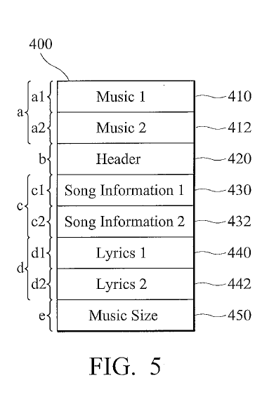

Further, the song information may comprise song ID, song title, performer, composer of song, information for whether multi-channel can be selected, language (nation) code, music index, and others. It is noted that a song may have several versions in different languages, such as Japanese, English, and Chinese. In these versions, the music may be the same, and the lyrics and song information may be different. The correct version of a song can be identified according to the song information. FIG. 4 shows an example of a music/lyrics/song information integrated file for two languages. As shown in FIG. 4, the music/lyrics/song information integrated file 400 comprises music 1 (410), header 420, song information 1 and 2 (430 and 432), lyrics 1 and 2 (440 and 442, and music size 450. The size of the music 1 (410) is “a”. The size of the header 420 is “b”. The size of the song information 1 (430) is “c1”, the size of the song information 2 (432) is “c2”, and the total size of the song information 1 and 2 (430 and 432) is “c”. The size of the lyrics 1 (440) is “d1”, the size of the lyrics 2 (442) is “d2”, and the total size of the lyrics 1 and 2 (440 and 442) is “d”. The size of the field of music size 450 is “e”. The value of the music size 450 is “a”, used for an offset of the music 1 410. In the example of FIG. 4, the number of the music block is 1, the number of the song information block is 2, the number of the lyrics block is 2, the size of the music 1 is “a1”, the size of the song information 1 is “c1”, the size of the song information 2 is “c2”, the size of the lyrics 1 is “d1”, and the size of the lyrics 2 is “d2”, recorded in the header 420. In this example, one music (music 1) and two groups of lyrics and song information are in the music/lyrics/song information integrated file 400. The version of the song can be identified according to the song information. During playback of the music 1, lyrics 1 or 2 can be selected for playback according to the song version. FIG. 5 shows another example of a music/lyrics/song information integrated file for two languages. As shown in FIG. 5, the music/lyrics/song information integrated file 400 comprises music 1 and 2 (410 and 412), header 420, song information 1 and 2 (430 and 432), lyrics 1 and 2 (440 and 442, and music size 450. The size of the music 1 (410) is “a1”, the size of the music 2 (412) is “a2”, and the total size of the music 1 and 2 (410 and 412) is “a”. The size of the header 420 is “b”. The size of the song information 1 (430) is “c1”, the size of the song information 2 (432) is “c2”, and the total size of the song information 1 and 2 (430 and 432) is “c”. The size of the lyrics 1 (440) is “d1”, the size of the lyrics 2 (442) is “d2”, and the total size of the lyrics 1 and 2 (440 and 442) is “d”. The size of the field of music size 450 is “e”. The value of the music size 450 is “a”, used for an offset of the music 1 and 2. In the example of FIG. 5, the number of the music block is 2, the number of the song information block is 2, the number of the lyrics block is 2, the size of the music 1 is “a1”, the size of the music 2 is “a2”, the size of the song information 1 is “c1”, the size of the song information 2 is “c2”, the size of the lyrics 1 is “d1”, and the size of the lyrics 2 is “d2”, recorded in the header 420. In this example, two music (music 1 and 2) and two groups of lyrics and song information are in the music/lyrics/song information integrated file 400. The version of the song can be identified according to the song information. Music 1 or 2, and lyrics 1 or 2 can be selected for playback according to the song version.

The processing module 220 receives a song index 250, such as song ID, song title, performer, composer of song, information for whether multi-channel can be selected, language code, and others, and retrieves a specific music/lyrics/song information integrated file 211 from the database, where the song information of the specific music/lyrics/song information integrated file 211 conforms to the song index 250. The processing module 220 reads the music, lyrics and song information from the music/lyrics/song information integrated file 211. The processing module 220 plays back the song corresponding to the music/lyrics/song information integrated file 211 by playing back the music via the audio output unit 230, and playing back (displaying) the lyrics and song information via the display unit 240.

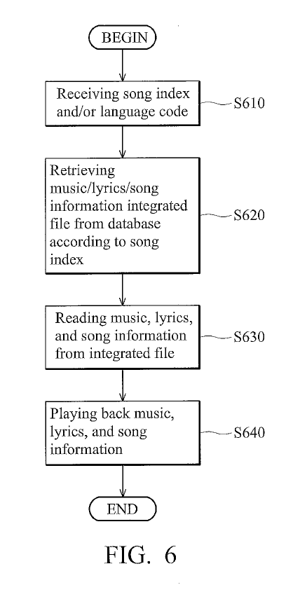

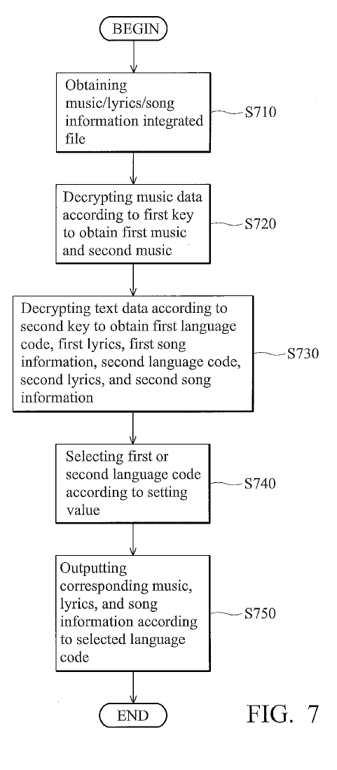

FIG. 6 is a flowchart of an embodiment of a playback method with integrated music, lyrics and song information.

In step S610, a specific song index, such as song ID, song title, and/or language code is received. It is understood that, in some embodiments, the language code can be integrated into the song index, and the language version for the music, lyrics, and song information can be identified according to the song index. In step S620, a specific music/lyrics/song information integrated file is retrieved from the database according to the specific song index, where the specific song index corresponds to the song information of the specific music/lyrics/song information integrated file. In step S630, music, lyrics, and song information are read from the specific music/lyrics/song information integrated file according to the language code. It is noted that if no language code is received in step S610, default music, lyrics, and song information are read from the specific music/lyrics/song information integrated file. In step S640, a song corresponding to the specific song index (the specific music/lyrics/song information integrated file) is played back by playing back the music via the audio output unit, and playing back the lyrics and song information via the display unit. It is understood that at least a specific portion, such as each sentence or section of lyrics of the lyrics has a time tag corresponding to a time point on the timeline of the music. During playback of the music, the specific portion in the lyrics is displayed on the corresponding time point.

FIG. 7 is a flowchart of an embodiment of a playback method with integrated music, lyrics and song information for use in a music/lyrics/song information integrated file.

In step S710, a music/lyrics/song information integrated file is obtained. The music/lyrics/song information integrated file corresponds to a song, and comprises encrypted music data, and encrypted text data. In step S720, the encrypted music data in the music/lyrics/song information integrated file is decrypted according to a first key to generate first music and second music. In step S730, the encrypted text data in the music/lyrics/song information integrated file is decrypted according to a second key to generate a first language code, first lyrics and first song information, a second language code, second lyrics and second song information. It is understood that, in some embodiments, the first language code and second language code may be comprised in the first song information and second song information, respectively. In step S740, the first language code or the second language code is selected according to a setting value. In step S750, the corresponding music, lyrics, and song information are output according to the selected language code. The music is played back via the audio output unit, and the lyrics and song information are displayed via the display unit. As described, the lyrics comprise at least a time tag corresponding to a time point of the music. During playback of the music, the lyrics are synchronously played back with the music on the corresponding time point.

It is understood that, in some embodiments, if a music/lyrics/song information integrated file comprises a music block and several lyrics and song information blocks, the music is played back, and the lyrics and song information corresponding to the setting value are played back. In some embodiments, if a music/lyrics/song information integrated file comprises a music block and a lyrics and song information block, the music, lyrics and song information can be directly output after decryption. Further, in some embodiments, if the music data and the text data are encrypted using the same encryption manner, a key can be used to decrypt the music data and the text data.

In the invention, music, lyrics, and song information are integrated into a file. If the songs have to be frequently replaced, replacement efficiency can be improved, and the possibility of file loss during replacement reduced. For a database system comprising a large amount of music, lyrics, and song information, data management and maintenance thereof can be improved, and data consistency ensured. Additionally, since the lyrics and song information are integrated and encrypted, data can be protected.

Further, the music data and text data such as lyrics and song information can be respectively protected with different encryption methods. The sources with different intellectual property can be individually protected, for music and lyrics, respectively.

Playback systems and methods with integrated music, lyrics and song information, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the device thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the device becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A playback system with integrated music, lyrics and song information, comprising:
a database storing a plurality of music/lyrics/song information integrated files, each corresponding to a song, and comprising first music, first lyrics, and first song information; and
a processing module retrieving a specific music/lyrics/song information integrated file from the database according to a specific song index, where the specific song index corresponds to the first song information of the specific music/lyrics/song information integrated file, reading the first music and the first lyrics from the specific music/lyrics/song information integrated file, and playing back a specific song corresponding to the specific music/lyrics/song information integrated file by playing back the first music and the first lyrics.

2. The system of claim 1 wherein the first lyrics has at least one time tag corresponding to a time point in the first music, and the processing module plays back the first lyrics on the time point during the playback of the first music.

3. The system of claim 1 wherein the processing module further decrypts the first music before the first music is played back.

4. The system of claim 1 further comprising an audio output unit outputting the first music during the playback of the specific song.

5. The system of claim 1 wherein the specific music/lyrics/song information integrated file further comprises second lyrics and second song information corresponding to the second lyrics, the first lyrics and first song information and the second lyrics and second song information respectively correspond to a language code, and the processing module further determines to read the first lyrics or the second lyrics from the specific music/lyrics/song information integrated file according to the language code, for playback.

6. The system of claim 5 wherein the specific music/lyrics/song information integrated file further comprises second music, the first music and first song information and the second music and second song information respectively correspond to a language code, and the processing module further determines to read the first music or the second music from the specific music/lyrics/song information integrated file according to the language code, for playback.

7. The system of claim 1 wherein the processing module further read the first song information from the specific music/lyrics/song information integrated file, for playback.

8. The system of claim 7 further comprising a display unit displaying the first lyrics and first song information during the playback of the specific song.

9. A playback method with integrated music, lyrics and song information, comprising:
providing a database storing a plurality of music/lyrics/song information integrated files, each corresponding to a song and comprising first music, first lyrics, and first song information;
retrieving a specific music/lyrics/song information integrated file from the database according to a specific song index, where the specific song index corresponds to the first song information of the specific music/lyrics/song information integrated file;
reading the first music and the first lyrics from the specific music/lyrics/song information integrated file; and
playing back a specific song corresponding to the specific music/lyrics/song information integrated file by playing back the first music and the first lyrics.

10. The method of claim 9 wherein the first lyrics has at least one time tag corresponding to a time point in the first music, and the method further comprises playing back the first lyrics on the time point during the playback of the first music.

11. The method of claim 9 further comprising decrypting the first music before the first music is played back.

12. The method of claim 9 further comprising outputting the first music via an audio output unit during the playback of the specific song.

13. The method of claim 9 wherein the specific music/lyrics/song information integrated file further comprises second lyrics and second song information corresponding to the second lyrics, the first lyrics and first song information and the second lyrics and second song information respectively correspond to a language code, and the method further comprises determining to read the first lyrics or the second lyrics from the specific music/lyrics/song information integrated file according to the language code, for playback.

14. The method of claim 13 wherein the specific music/lyrics/song information integrated file further comprises second music, the first music and first song information and the second music and second song information respectively correspond to a language code, and the method further comprises determining to read the first music or the second music from the specific music/lyrics/song information integrated file according to the language code, for playback.

15. The method of claim 9 further comprising reading the first song information from the specific music/lyrics/song information integrated file, for playback.

16. The method of claim 15 further comprising displaying the first lyrics and first song information via a display unit during the playback of the specific song.
